(19) United States
(12) Patent Application Publication
(10) Pub. No.: US 2025/0330763 A1
(43) Pub. Date: Oct. 23, 2025

(54) INFORMATION PROCESSING DEVICE, INFORMATION PROCESSING METHOD, AND PROGRAM

(71) Applicant: Sony Group Corporation, Tokyo (JP)

(72) Inventor: Takayoshi SHIMIZU, Chiba (JP)

(73) Assignee: Sony Group Corporation, Tokyo (JP)

(21) Appl. No.: 18/868,182

(22) PCT Filed: May 22, 2023
(86) PCT No.: PCT/JP2023/018870

§ 371 Date: Nov. 22, 2024

(30) Foreign Application Priority Data
Jun. 10, 2022 (JP) 2022-094451

(51) Int. Cl. H04S 7/00; G06T 19/00

(52) U.S. Cl. CPC H04S 7/303; G06T 19/00; H04S 7/305; H04S 2400/11

(57) ABSTRACT

There is provided an information processing device, an information processing method, and a program that can provide a user experience with a further improved sense of reality. When a second avatar associated with a second user is present in a scene or a plurality of areas associated with a virtual space in which a first avatar associated with a first user is present, a voice acquisition unit acquires a voice of the second user, an acoustic environment determination processing unit performs acoustic environment determination processing of determining an acoustic environment of the scene or the areas in which the first avatar is present based on a collider associated with the scene or the areas, and an acoustic characteristics application unit applies acoustic characteristics matching a processing result of the acoustic environment determination processing to the voice of the second user. The present technology can be applied to, for example, a system that provides a metaverse virtual space.

### TECHNICAL FIELD

The present disclosure relates to an information processing device, an information processing method, and a program, and more particularly relates to an information processing device, an information processing method, and a program that can provide a user experience with a further improved sense of reality.

### BACKGROUND ART

Conventionally, in a metaverse virtual space, a plurality of scenes (virtual spaces) are provided in one world, and a user can freely move an own avatar between scenes. Furthermore, when a plurality of avatars are present in an identical scene, the metaverse virtual space provides user experiences that enable users of these avatars to communicate by remote call by means of voice chat.

Furthermore, various environments such as an indoor environment and an outdoor environment are provided to scenes in the metaverse virtual space, and it is possible to provide a user experience with an improved sense of reality by outputting an environmental sound to which an acoustic effect (a reverberation effect generated by sound reflection characteristics) suitable to the respective environments has been applied. When, for example, a scene is a cave in the metaverse virtual space, a user can experience a sense of reality that the user is in the cave by reverberating an environmental sound of a water drop, a living thing, or the like in the cave.

Furthermore, PTL 1 proposes an online conversation system that facilitate hearing of a conversation in a virtual space by transmitting group conversion data indicating a conversation of a user of a user terminal belonging to a conversation group, and position coordinates related to the conversation group.

### CITATION LIST

### Patent Literature

PTL 1: JP 2010-122826A

### SUMMARY

### Technical Problem

By the way, conventionally, an acoustic effect suitable to an environment is applied to an environmental sound as described above. By contrast with this, it is concerned that, when, for example, a similar acoustic effect is not applied in real time to a voice of another user who is a conversation partner, the sense of existence of the conversation partner is lost as voice chat starts and, as a result, the sense of reality of the metaverse virtual space is lost.

With such a situation in view, the present disclosure can provide a user experience with a further improved sense of reality.

### Solution to Problem

An information processing device according to one aspect of the present disclosure includes: a voice acquisition unit that, when a second avatar associated with a second user is present in a scene or a plurality of areas associated with a virtual space in which a first avatar associated with a first user is present, acquires a voice of the second user; an acoustic environment determination processing unit that performs acoustic environment determination processing of determining an acoustic environment of the scene or the areas in which the first avatar is present based on a collider associated with the scene or the areas; and an acoustic characteristics application unit that applies acoustic characteristics matching a processing result of the acoustic environment determination processing to the voice of the second user.

An information processing method or a program according to one aspect of the present disclosure includes: when a second avatar associated with a second user is present in a scene or a plurality of areas associated with a virtual space in which a first avatar associated with a first user is present, acquiring a voice of the second user; performing acoustic environment determination processing of determining an acoustic environment of the scene or the areas in which the first avatar is present based on a collider associated with the scene or the areas; and applying acoustic characteristics matching a processing result of the acoustic environment determination processing to the voice of the second user.

According to one aspect of the present disclosure, when the second avatar associated with the second user is present in the scene or the plurality of areas associated with the virtual space in which the first avatar associated with the first user is present, the voice of the second user is acquired, acoustic environment determination processing of determining the acoustic environment of the scene or the areas in which the first avatar is present is performed based on the collider associated with the scene or the areas, and acoustic characteristics matching the processing result of the acoustic environment determination processing are applied to the voice of the second user.

### BRIEF DESCRIPTION OF DRAWINGS

FIG. 1 is a block diagram illustrating a configuration example of an embodiment of a metaverse virtual space system to which the present technology is applied.

FIG. 2 is a diagram for explaining a scene provided to a metaverse virtual space.

FIG. 3 is a diagram for explaining acoustic environment determination processing that uses scene colliders.

FIG. 4 is a diagram for explaining an area.

FIG. 5 is a block diagram illustrating a configuration example of an acoustic characteristics processing unit.

FIG. 6 is a flowchart for explaining first acoustic characteristics processing.

FIG. 7 explains acoustic environment determination processing at a time when spatial transformation occurs.

FIG. 8 is a flowchart for explaining second acoustic characteristics processing.

FIG. 9 is a diagram for explaining acoustic environment determination processing at a time when climate change occurs.

FIG. 10 is a flowchart for explaining third acoustic characteristics processing.

FIG. 11 is a block diagram illustrating a configuration example of an embodiment of a computer to which the present technology is applied.

### DESCRIPTION OF EMBODIMENTS

Hereinafter, a specific embodiment to which the present technology is applied will be described in detail with reference to the drawings.

### Configuration Example of Metaverse Virtual Space System

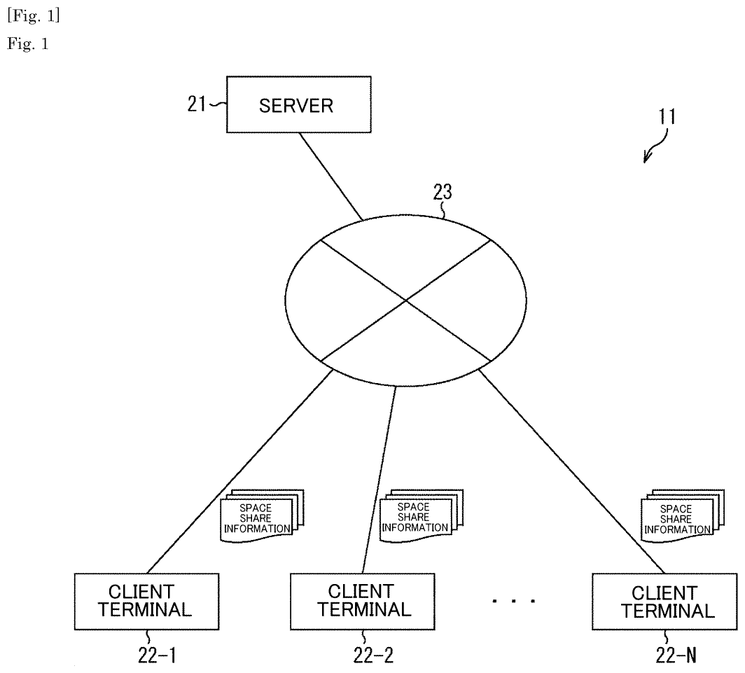

FIG. 1 is a block diagram illustrating a configuration example of an embodiment of a metaverse virtual space system to which the present technology is applied.

As illustrated in FIG. 1, a metaverse virtual space system 11 is configured by connecting a server 21 and a plurality of client terminals 22 via a network 23 such as the Internet, and provides a metaverse virtual space to users of the respective client terminals 22. In an example illustrated in FIG. 1, N users join the metaverse virtual space, and N client terminals 22-1 to 22-N are connected to the network 23. Consequently, a plurality of avatars respectively associated with a plurality of users can be present in the metaverse virtual space, one avatar is associated with one user, and each user can move in the metaverse virtual space by operating the avatar associated with the own user. Note that the client terminals 22-1 to 22-N are configured likewise, and will be referred to simply as the client terminal 22 when these client terminals 22-1 to 22-N do not need to be distinguished.

The server 21 transmits to the client terminal 22 via the network 23 space share information that is necessary to share the metaverse virtual space between the plurality of users and provide user experiences in the metaverse virtual space. For example, the space share information includes avatar position information that indicates a position of each avatar in the metaverse virtual space, avatar motion information that indicates a motion of each avatar in the metaverse virtual space, position information of an avatar possession that indicates a position of an item possessed by each avatar in the metaverse virtual space, and dialogue window AV stream information that includes data of a video and a sound for a bidirectional dialogue via a dialogue window without avatars joining together in the metaverse virtual space.

The client terminal 22 reproduces the metaverse virtual space based on the space share information transmitted from the server 21 via the network 23. Furthermore, the client terminal 22 includes a microphone that acquires a voice spoken by a user, and a speaker that outputs a voice corresponding to voice data transmitted from the server 21 or the another client terminal 22. Furthermore, the client terminal 22 transmits to the server 21 the voice data of the user's voice acquired by the microphone, and outputs from the speaker a voice of another user corresponding to the received voice data such that users who share the metaverse virtual space converse with each other. That is, the client terminal 22 displays on a display a video of the metaverse virtual space in a range that the avatar of the user itself can see, and outputs from the speaker a sound of the metaverse virtual space (such as an environmental sound of each scene and each area or a voice of a user who is a conversation partner) that the avatar of the user itself can hear. For example, as the client terminal 22, various devices such as a head mount display, a personal computer, a tablet terminal, and a smartphone can be used.

The metaverse virtual space system 11 configured as described above provides the metaverse virtual space, and the user can log in and log out from the metaverse virtual space by operating the client terminal 22.

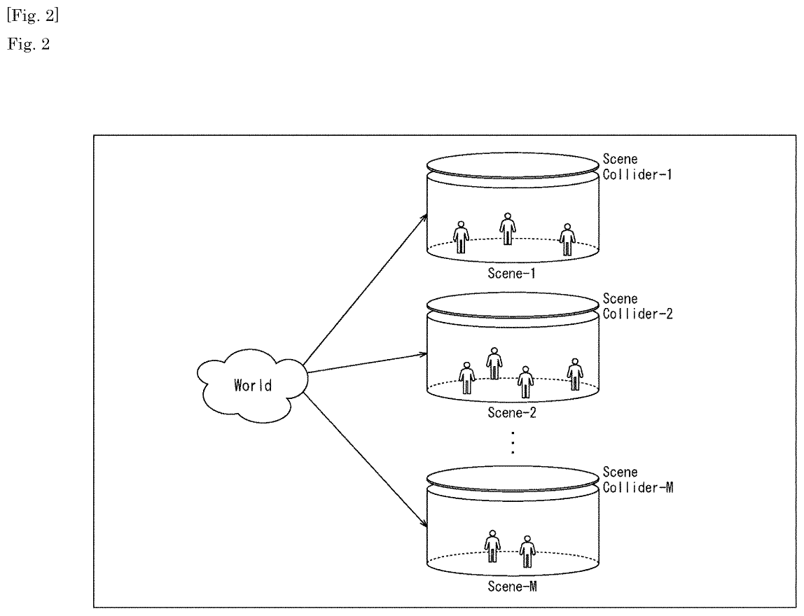

Furthermore, as illustrated in FIG. 2, a plurality of scenes (virtual spaces) are provided in one world in the metaverse virtual space. FIG. 2 illustrates an example of the metaverse virtual space provided with M Scenes Scene-1 to Scene-M in the one world.

For example, the user can select a desired scene of the Scenes Scene-1 to Scene-M and freely move the avatar in this scene by operating the client terminal 22. Furthermore, in the metaverse virtual space, users of avatars present in the same scene can communicate with each other by performing bidirectional voice call by voice chat.

Furthermore, in the metaverse virtual space, acoustic characteristics to be applied to an environmental sound of an environment of each of the scenes Scene-1 to Scene-M (e.g., a sound such as wind sound or rain sound that is heard in a natural environment or a sound such as footsteps or noise that is heard in a living environment) are preset. Furthermore, when the user moves the avatar to one of the scenes Scene-1 to Scene-M, the acoustic characteristics preset to the movement destination scene are applied to the environmental sound at a time of playback of the environmental sound, and the environmental sound to which the preset acoustic characteristics have been applied is output. For example, as an example of the acoustic characteristics, acoustic characteristics matching an environment such as a square, a street, and a natural environment (e.g., a mountaintop, a river, or a forest) are used in an outdoor scene, and acoustic characteristics matching an environment such as a cave, a church, a live show venue, or a theater are used in an indoor scene.

Furthermore, in the metaverse virtual space, when a voice spoken by another user who is a conversation partner is acquired, acoustic characteristics suitable to an acoustic environment at a position at which the avatar of the user itself (first user) is present in the metaverse virtual space at this point of time are applied to the voice of the conversation partner (second user). To, for example, specify the acoustic characteristics suitable to the acoustic environment at the position at which the avatar is present, scene colliders SceneCollider-1 to SceneCollider-M are disposed covering ceilings of respective spaces of the scenes Scene-1 to Scene-M in the metaverse virtual space. Furthermore, the scene colliders SceneCollider-1 to SceneCollider-M are respectively associated with scene acoustic IDs for identifying acoustic characteristics. Furthermore, by identifying an acoustic environment at the position of the avatar of the user itself by acoustic environment determination processing that uses the scene colliders SceneCollider-1 to SceneCollider-M, it is possible to apply to the voice of the conversation partner the acoustic characteristics suitable to the acoustic environment at the position of the avatar of the user itself.

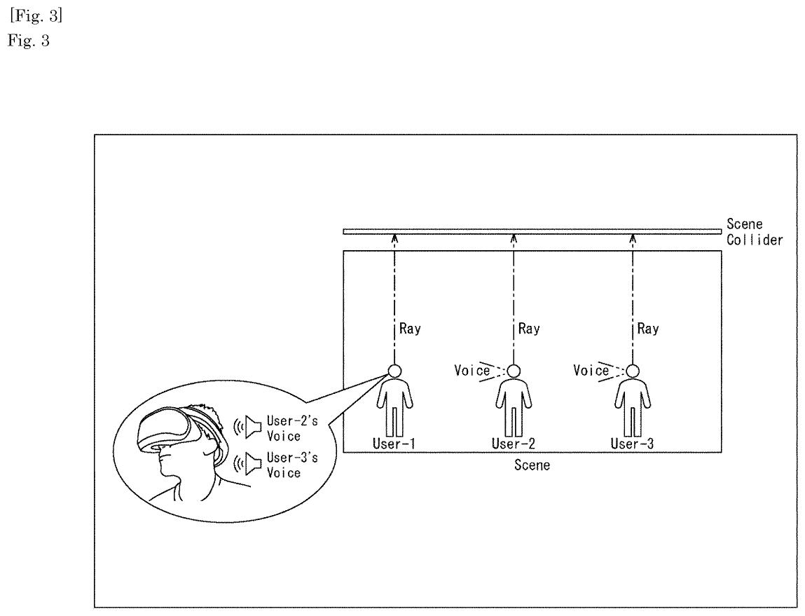

The acoustic environment determination processing that uses the scene colliders will be described with reference to FIG. 3.

As described above with reference to FIG. 2, the scene colliders are disposed covering a ceiling of a space of a scene in the metaverse virtual space system 11. Furthermore, according to the acoustic environment determination processing, a determination ray is output from the top of the head of each avatar (e.g., a position of a virtual camera and a coordinate position of each avatar) toward above the sky, so that it is possible to determine an acoustic environment at a position of an individual avatar based on a scene collider that this determination ray has hit, that is, hit determination of the scene collider. According to such acoustic environment determination processing, the metaverse virtual space system 11 acquires a scene acoustic ID associated with a scene collider, and applies the acoustic characteristics identified based on this acquired scene acoustic ID to the voice of the conversation partner.

Consequently, when avatars of a user 2 and a user 3 are present in the same scene as that of an avatar of a user 1 as illustrated in FIG. 3, acoustic characteristics processing of applying acoustic characteristics suitable to an acoustic environment at a position of the avatar of the user 1 to a voice acquired by the microphones of the client terminals 22 used by the user 2 and the user 3 is performed. Furthermore, voice data to which such acoustic characteristics have been applied is transmitted from the server 21 to the client terminal 22 used by the user 1, and the voice corresponding to the voice data is output from the speaker of the client terminal 22. As described above, the metaverse virtual space system 11 can provide a user experience with a further improved sense of reality.

According to, for example, the acoustic environment determination processing that uses the scene colliders, even when an avatar moves in a horizontal direction or a vertical direction, it is possible to determine an acoustic environment of a scene at all times based on the scene collider provided to cover the scene. Consequently, even when an acoustic environment changes while the avatar moves while performing voice chat with the conversation partner, the metaverse virtual space system 11 can apply appropriate acoustic characteristics in real time to the voice of the conversation partner.

Note that, while it is indispensable to apply the acoustic characteristics to the voice of the conversation partner, for example, the metaverse virtual space system 11 may apply or may not apply the acoustic characteristics to the voice of the user itself depending on processing capability of the entire system.

Furthermore, it is possible to provide a plurality of areas (e.g., an outdoor area, a corridor in a building, and a room in a building) to a scene in the metaverse virtual space, and voice characteristics to be applied to an environmental sound in an environment of each area are preset similarly to the above-described scene.

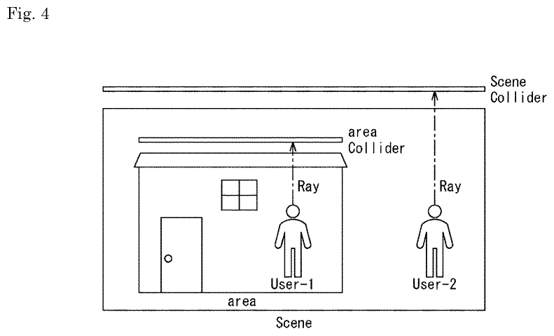

For example, FIG. 4 illustrates an example of a scene provided with one area.

For example, an area collider is disposed covering a ceiling of an area, and the area collider is associated with an area acoustic ID for identifying acoustic characteristics of each area. Consequently, it is possible to determine an acoustic environment associated with each area in a similar way how an acoustic environment associated with a scene is determined as described above. When, for example, the avatar of the user 1 is present in the area as illustrated in FIG. 4, the acoustic characteristics of the area are applied to the environmental sound and the voice of the conversation partner, and, when the avatar of the user 2 is present outside the area, the acoustic characteristics of the scene are applied to the environmental sound and the voice of the conversation partner.

That is, the metaverse virtual space system 11 determines acoustic characteristics suitable to an acoustic environment at a position at which the avatar of the user itself is present in the metaverse virtual space based on the scene colliders or area colliders. Consequently, acoustic characteristics suitable to each scene or area are applied to an environmental sound and a voice of a conversation partner, so that it is possible to increase the sense of reality of the metaverse virtual space.

### Configuration Example of Acoustic Characteristics Processing Unit

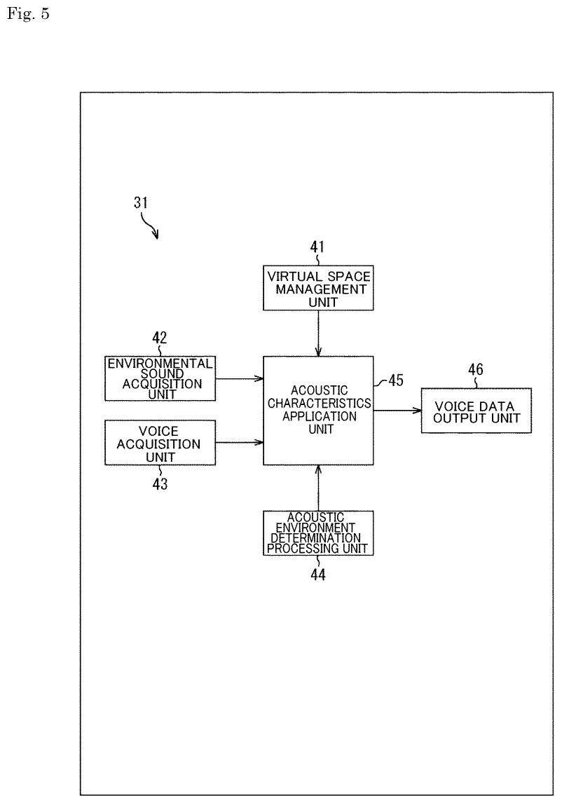

FIG. 5 is a block diagram illustrating a configuration example of an acoustic characteristics processing unit that executes acoustic characteristics processing for applying appropriate acoustic characteristics in the metaverse virtual space system 11.

As illustrated in FIG. 5, an acoustic characteristics processing unit 31 includes a virtual space management unit 41, an environmental sound acquisition unit 42, a voice acquisition unit 43, an acoustic environment determination processing unit 44, an acoustic characteristics application unit 45, and a voice data output unit 46.

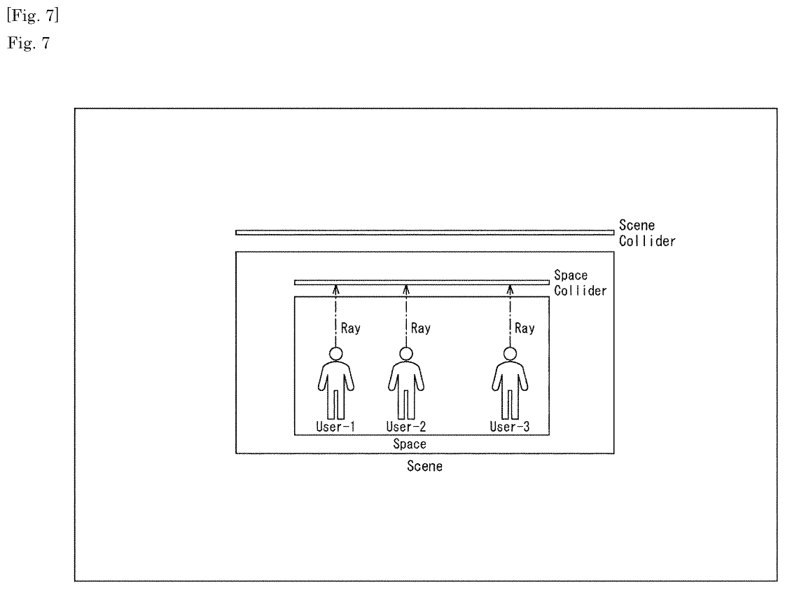

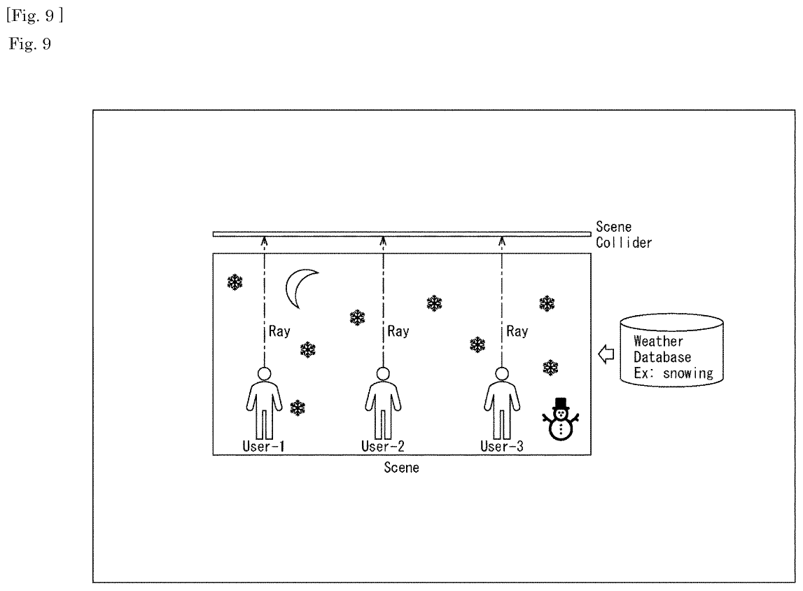

The virtual space management unit 41 performs various processing related to management of the metaverse virtual space provided by the metaverse virtual space system 11. For example, the virtual space management unit 41 performs log-in processing for a user to log in the metaverse virtual space, log-out processing for the user to log out from the metaverse virtual space, and the like in response to a user's operation. Furthermore, the virtual space management unit 41 performs avatar movement processing for moving an avatar between scenes in response to a user's operation, and supplies to the acoustic characteristics application unit 45 a preset acoustic ID for identifying acoustic characteristics preset to a movement destination scene to which the avatar has moved. Furthermore, the virtual space management unit 41 also performs processing related to spatial transformation as described later with reference to FIG. 7, processing related to climate change as described later with reference to FIG. 9, and the like.

The environmental sound acquisition unit 42 acquires an environmental sound of a scene or an area in which the avatar of the user itself is present, and supplies the environmental sound to the acoustic characteristics application unit 45.

When an avatar of another user is present in the same scene or area as that of the avatar of the user itself, and when the voice acquisition unit 43 acquires by the microphone a voice spoken by the another user and receives an input of voice data transmitted from the client terminal 22, the voice acquisition unit 43 acquires and supplies this voice to the acoustic characteristics application unit 45.

As described above with reference to FIG. 3, the acoustic environment determination processing unit 44 performs acoustic environment determination processing of outputting a determination ray from the top of the head of the avatar of the user itself toward above the sky, and determining an acoustic environment of a scene or an area at a position of the avatar of the user itself based on a scene collider or an area collider that this determination ray has hit. Furthermore, the acoustic environment determination processing unit 44 acquires a scene acoustic ID or an area acoustic ID associated with the scene collider or the area collider hit by the determination ray as a scene acoustic ID or an area acoustic ID for identifying acoustic characteristics suitable to the position of the avatar of the user itself according to a processing result of the acoustic environment determination processing unit, and supplies the scene acoustic ID or the area acoustic ID to the acoustic characteristics application unit 45.

The acoustic characteristics application unit 45 applies the acoustic characteristics identified based on the preset acoustic ID supplied from the virtual space management unit 41 to the environmental sound supplied from the environmental sound acquisition unit 42, and supplies to the voice data output unit 46 the environmental sound to which the preset acoustic characteristics have been applied. Furthermore, the acoustic characteristics application unit 45 applies the acoustic characteristics identified based on the scene acoustic ID or the area acoustic ID supplied from the acoustic environment determination processing unit 44 to the voice of the conversation partner supplied from the voice acquisition unit 43, and supplies to the voice data output unit 46 the voice of the conversation partner to which the acoustic characteristics suitable to the position of the avatar of the user itself have been applied.

Furthermore, the acoustic characteristics application unit 45 adjusts a reverberation amount for the voice of the conversation partner based on predetermined attribute information. For example, the degree of intimacy and the degree of contribution of another user with respect to the user itself can be used for the attribute information, and the acoustic characteristics application unit 45 adjusts the reverberation amount to increase for the voice of the conversation partner having a high degree of intimacy and a high degree of contribution. Consequently, it is possible to make the user readily notice the voice of the conversation partner having the high degree of intimacy and the high degree of contribution from a plurality of conversation partners. More specifically, by increasing the reverberation amount of a conversation partner (fan) having a high degree of intimacy and a high degree of contribution in a scene such as a music live or a handshake event, it is possible to make a user (streamer) who holds the music live or the handshake event live readily notice the voice of this conversation partner.

The voice data output unit 46 outputs to each client terminal 22 voice data indicating the environmental sound and the voice supplied from the acoustic characteristics application unit 45.

The acoustic characteristics processing unit 31 is configured as described above, and the acoustic environment determination processing unit 44 performs acoustic environment determination processing, so that it is possible to output a voice of a conversation partner to which appropriate acoustic characteristics have been applied in a scene or an area of a position of an avatar, and provide a user experience with a further improved sense of reality.

When, for example, the user moves the avatar across scenes or areas while conversing with another user, the acoustic characteristics processing unit 31 can apply, to the voice of the conversation partner, acoustic characteristics appropriate for a movement destination scene or area at all times in conjunction with movement of the avatar to the scene or the area. Consequently, the metaverse virtual space system 11 can prevent the user from losing a sense that the user is in this scene or area, that is, the sense of reality. Note that, although a position in a virtual space can be determined by coordinate determination, while an arithmetic operation load and occurrence of erroneous determination are assumed in a virtual space of a complicated shape, the metaverse virtual space system 11 can avoid the arithmetic operation load and occurrence of erroneous determination by the acoustic environment determination processing that uses scene colliders or area colliders.

Note that each block constituting the acoustic characteristics processing unit 31 may be provided to one of the server 21 and the plurality of client terminals 22 constituting the metaverse virtual space system 11, or may be dispersed and provided in the server 21 and the plurality of client terminals 22.

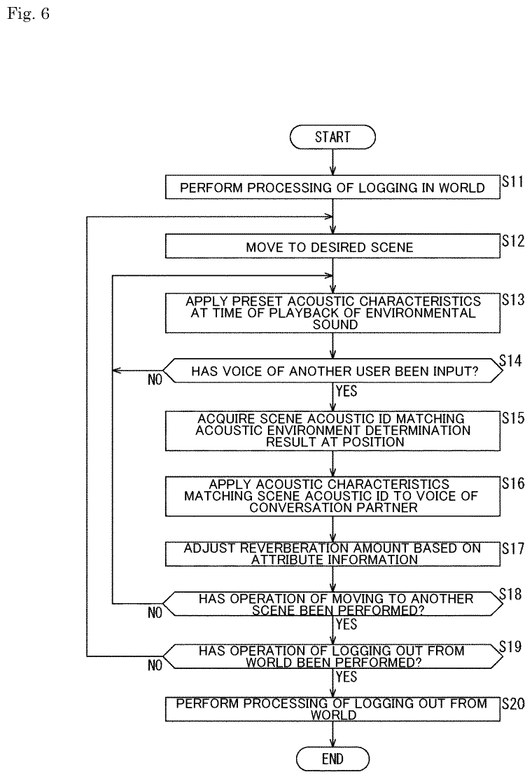

First acoustic characteristics processing performed by the acoustic characteristics processing unit 31 will be described with reference to a flowchart illustrated in FIG. 6.

When, for example, the user operates the client terminal 22 and requests log-in in the metaverse virtual space provided by the metaverse virtual space system 11, the virtual space management unit 41 performs processing of logging in the world of the metaverse virtual space in step S11.

In step S12, when the user operates the client terminal 22, and selects a desired scene among a plurality of scenes provided in the world of the metaverse virtual space, the virtual space management unit 41 performs avatar movement processing of moving the avatar to the desired scene. Furthermore, the virtual space management unit 41 supplies to the acoustic characteristics application unit 45 a preset acoustic ID for identifying acoustic characteristics preset to the movement destination scene to which the avatar has moved.

In step S13, the environmental sound acquisition unit 42 acquires an environmental sound of the movement destination scene to which the avatar has moved, that is, an environmental sound in a scene in which the avatar of the user itself is present at a current point of time after the movement, and supplies the environmental sound to the acoustic characteristics application unit 45. The acoustic characteristics application unit 45 applies the acoustic characteristics identified based on the preset acoustic ID supplied from the virtual space management unit 41 in step S12 to the environmental sound supplied from the environmental sound acquisition unit 42, and outputs the environmental sound to which the preset acoustic characteristics have been applied.

In step S14, the voice acquisition unit 43 determines whether or not a voice of another user associated with an avatar in the same scene has been input. When the voice acquisition unit 43 determines in step S14 that the voice of the another user associated with the avatar present in the same scene is not input, the processing returns to step S13, and the same processing is repeatedly performed thereafter. On the other hand, when determining in step S14 that the voice of the another user associated with the avatar in the same scene has been input, the voice acquisition unit 43 acquires and supplies the voice of this conversation partner to the acoustic characteristics application unit 45, and the processing proceeds to step S15.

In step S15, the acoustic environment determination processing unit 44 performs acoustic environment determination processing of determining an acoustic environment at a position of the avatar of the user itself, acquires a scene acoustic ID matching a processing result of the acoustic environment determination processing, that is, acquires a scene acoustic ID associated with a scene collider that a determination ray output from a top of a head of the avatar of the user itself toward above the sky has hit, and supplies the scene acoustic ID to the acoustic characteristics application unit 45.

In step S16, the acoustic characteristics application unit 45 applies the acoustic characteristics matching the scene acoustic ID supplied from the acoustic environment determination processing unit 44 in step S15 to the voice of the conversation partner supplied from the voice acquisition unit 43 in step S14.

In step S17, the acoustic characteristics application unit 45 adjusts a reverberation amount based on attribute information (such as the above-described degree of intimacy and degree of contribution) for the voice of the conversation partner to which the acoustic characteristics have been applied in step S16. Furthermore, the acoustic characteristics application unit 45 outputs the voice of the conversation partner to which the acoustic characteristics suitable to the position of the avatar of the user itself have been applied and for which the reverberation amount has been adjusted based on the predetermined attribute information.

In step S18, the virtual space management unit 41 determines whether or not the user has performed a movement operation of moving the avatar to another scene. When the virtual space management unit 41 determines in step S18 that the user has not performed the movement operation of moving the avatar to the another scene, the processing returns to step S13, and the same processing is repeatedly performed thereafter. On the other hand, when the virtual space management unit 41 determines in step S18 that the user has performed the movement operation of moving the avatar to the another scene, the processing proceeds to step S19.

In step S19, the virtual space management unit 41 determines whether or not the user has performed a log-out operation of logging out from the world of the metaverse virtual space. When the virtual space management unit 41 determines in step S19 that the user has not performed the log-out operation, the processing returns to step S12, and the same processing is repeatedly performed thereafter. On the other hand, when the virtual space management unit 41 determines in step S19 that the user has performed the log-out operation, the processing proceeds to step S20.

In step S20, the virtual space management unit 41 performs the log-out processing of logging out from the world of the metaverse virtual space provided by the metaverse virtual space system 11, and then the processing is finished.

As described above, the acoustic characteristics processing unit 31 performs the first acoustic characteristics processing, so that it is possible to output a voice of a conversation partner to which appropriate acoustic characteristics in a movement destination scene have been applied in conjunction with movement of an avatar to a scene.

Furthermore, the acoustic characteristics processing unit 31 can control the acoustic characteristics to be applied to a voice of another user based on a distance between an avatar of a user itself and an avatar of the another user in the metaverse virtual space. When, for example, the distance between the avatar of the user itself and the avatar of the another user in the metaverse virtual space exceeds a predetermined value, that is, the avatars are apart from each other, the acoustic characteristics processing unit 31 performs control (mute) of muting the voice of the another user. As described above, even for avatars present in the same scene or area, the voice of the another user may not be necessarily unmuted depending on a distance between the avatars.

Furthermore, the acoustic characteristics processing unit 31 can control acoustic characteristics to be applied to the voice of the another user based on the number of avatars present in the same scene or area. Only when, for example, the number of avatars exceeds a threshold, that is, in a case of a scene or an area in which there are too much avatars, the acoustic characteristics processing unit 31 may apply acoustic characteristics (e.g., adjust a reverberation amount) based on the attribute information.

### Processing Example at Time of Occurrence of Spatial Transformation

Acoustic environment determination processing at a time when spatial transformation occurs will be described with reference to FIG. 7.

As described above, the metaverse virtual space system 11 can apply, to the voice of the conversation partner, acoustic characteristics appropriate for a movement destination scene in conjunction with movement of the avatar to the scene. Furthermore, the metaverse virtual space system 11 can apply acoustic characteristics appropriate for a transformed space to the voice of the conversation partner in conjunction with occurrence of spatial transformation in a scene even when the avatar does not move between the scenes.

For example, it is assumed that, as illustrated in FIG. 7, spatial transformation occurs such that a closed space Space is provided inside a certain scene Scene to cover a plurality of avatars present in the certain scene Scene. Furthermore, similarly to the scene colliders SceneCollider provided to cover the ceiling of the scene Scene, space colliders SpaceCollider are provided to the closed space Space covering a ceiling, and the space collider SpaceCollider is associated with a space acoustic ID. Hence, an avatar in the closed space Space can output a determination ray from the top of the head toward above the sky, and determine an acoustic environment at a position of the avatar, that is, the acoustic environment suitable to the closed space Space based on the space collider SpaceCollider that this determination ray has hit.

Consequently, even when spatial transformation occurs in a scene and when an environmental sound in a closed space and a voice of a conversation partner are played back, the metaverse virtual space system 11 can apply, to these sounds, acoustic characteristics suitable to the closed space. Note that, when playing back an environmental sound outside the closed space and a voice of a conversation partner outside the closed space, the metaverse virtual space system 11 can provide a more sense of presence by muting these sounds or playing back these sounds at a volume to such a degree that these sounds can be faintly heard.

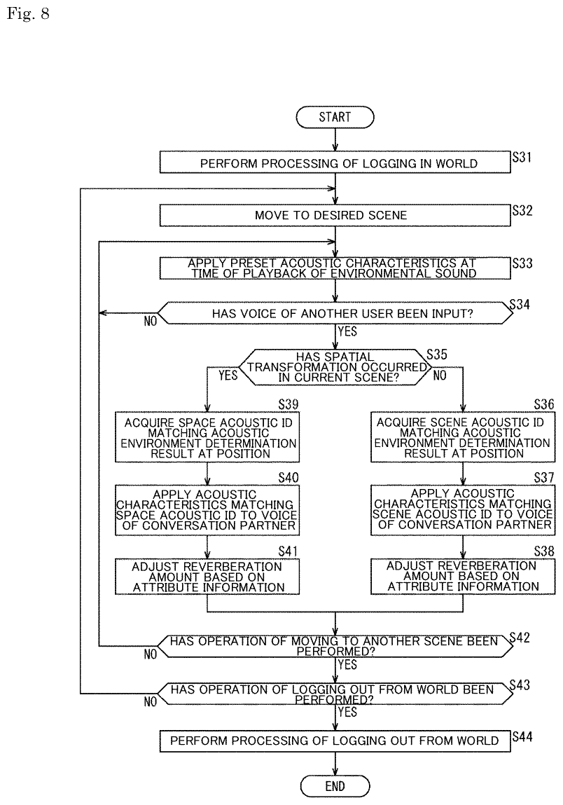

Second acoustic characteristics processing performed by the acoustic characteristics processing unit 31 will be described with reference to a flowchart illustrated in FIG. 8.

In steps S31 to S34, the same processing as those in steps S11 to S14 in FIG. 6 is performed. Furthermore, when determining in step S34 that a voice of another user associated with an avatar in the same scene has been input, the voice acquisition unit 43 acquires and supplies the voice of this conversation partner to the acoustic characteristics application unit 45, and the processing proceeds to step S35.

In step S35, the virtual space management unit 41 determines whether or not spatial transformation has occurred in a current scene, and, when it is determined that the spatial transformation does not occur in the current scene, the processing proceeds to step S36. Furthermore, in steps S36 to S38, the same processing as those in steps S15 to S17 in FIG. 6 is performed.

On the other hand, when the virtual space management unit 41 determines in step S35 that the spatial transformation has occurred in the current scene, the processing proceeds to step S39.

In step S39, the acoustic environment determination processing unit 44 performs acoustic environment determination processing of determining an acoustic environment at a position of the avatar of the user itself, acquires a space acoustic ID matching a processing result of the acoustic environment determination processing, that is, acquires a space acoustic ID associated with a space collider that a determination ray output from a top of a head of the avatar of the user itself toward above the sky has hit, and supplies the space acoustic ID to the acoustic characteristics application unit 45.

In step S40, the acoustic characteristics application unit 45 applies the acoustic characteristics matching the space acoustic ID supplied from the acoustic environment determination processing unit 44 in step S39 to the voice of the conversation partner supplied from the voice acquisition unit 43 in step S34.

In step S41, the acoustic characteristics application unit 45 adjusts a reverberation amount based on attribute information (such as the above-described degree of intimacy and degree of contribution) for the voice of the conversation partner to which the acoustic characteristics have been applied in step S40. Furthermore, the acoustic characteristics application unit 45 outputs the voice of the conversation partner to which the acoustic characteristics suitable to the position of the avatar of the user itself have been applied and for which the reverberation amount has been adjusted based on the predetermined attribute information.

After the processing in step S38 or S41, the processing proceeds to step S42. Furthermore, in step S42 to step S44, the same processing as those in steps S18 to S20 in FIG. 6 is performed.

As described above, the acoustic characteristics processing unit 31 performs the second acoustic characteristics processing, so that it is possible to output a voice of a conversation partner to which appropriate acoustic characteristics in each scene have been applied in conjunction with spatial transformation in a scene.

### Processing Example at Time of Occurrence of Climate Change

Acoustic environment determination processing at a time when climate change occurs will be described with reference to FIG. 9.

The metaverse virtual space system 11 can cause climate change when, for example, a scene is an outdoor virtual space.

For example, in the acoustic characteristics processing unit 31, the virtual space management unit 41 can determine whether or not climate change has occurred. Furthermore, when the climate change occurs, the acoustic characteristics application unit 45 can apply acoustic characteristics suitable to a weather after the climate change to an environmental sound and a voice of a conversation partner when referring to a weather database in which acoustic characteristics matching respective weathers are registered, and playing back the environmental sound in a scene and the voice of the conversation partner. For example, FIG. 9 illustrates that a scene becomes a snowy night as an example of climate change, and acoustic characteristics to increase a reverberation amount are applied at the snowy night.

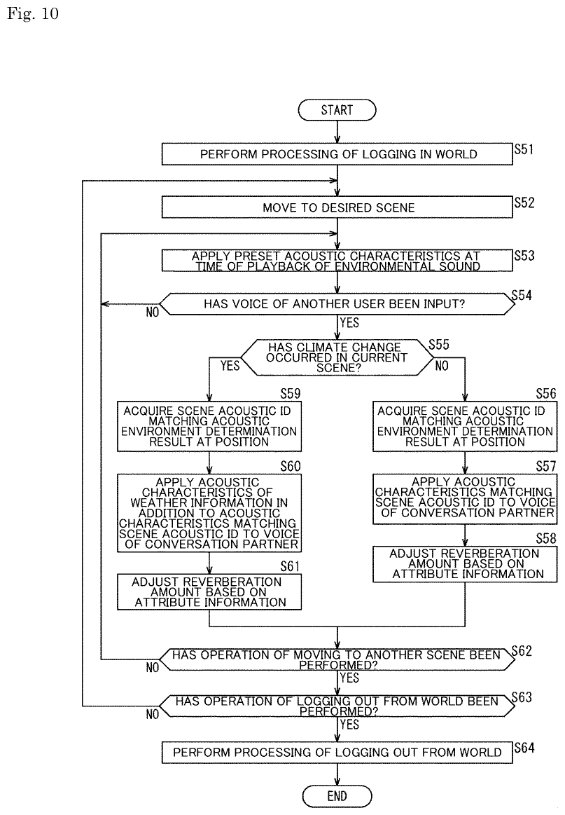

Third acoustic characteristics processing performed by the acoustic characteristics processing unit 31 will be described with reference to a flowchart illustrated in FIG. 10.

In steps S51 to S54, the same processing as those in steps S11 to S14 in FIG. 6 is performed. Furthermore, when determining in step S54 that a voice of another user associated with an avatar in the same scene has been input, the voice acquisition unit 43 acquires and supplies the voice of this conversation partner to the acoustic characteristics application unit 45, and the processing proceeds to step S55.

In step S55, the virtual space management unit 41 determines whether or not the climate change has occurred in the current scene, and, when it is determined that the climate change does not occur in the current scene, the processing proceeds to step S56. Furthermore, in steps S56 to S58, the same processing as those in steps S15 to S17 in FIG. 6 is performed.

On the other hand, when the virtual space management unit 41 determines in step S55 that the climate change has occurred in the current scene, the processing proceeds to step S59.

In step S59, the acoustic environment determination processing unit 44 performs the acoustic environment determination processing of determining an acoustic environment at the position of the avatar of the user itself, acquires a scene acoustic ID matching a processing result of the acoustic environment determination processing, that is, acquires a scene acoustic ID associated with a scene collider that a determination ray output from a top of a head of the avatar of the user itself toward above the sky has hit, and supplies the scene acoustic ID to the acoustic characteristics application unit 45.

In step S60, the acoustic characteristics application unit 45 adds acoustic characteristics matching the space acoustic ID supplied from the acoustic environment determination processing unit 44 in step S59 to the voice of the conversation partner supplied from the voice acquisition unit 43 in step S54, acquires acoustic characteristics matching a weather in the current scene referring to the weather database, and applies these acoustic characteristics.

In step S61, the acoustic characteristics application unit 45 adjusts a reverberation amount based on attribute information (such as the above-described degree of intimacy and degree of contribution) for the voice of the conversation partner to which the acoustic characteristics have been applied in step S60. Furthermore, the acoustic characteristics application unit 45 applies acoustic characteristics suitable to the position of the avatar of the user itself and weather information, and outputs the voice of the conversation partner whose reverberation amount has been adjusted based on predetermined attribute information.

After the processing in step S58 or S61, the processing proceeds to step S62. Furthermore, in step S62 to step S64, the same processing as those in steps S18 to S20 in FIG. 6 is performed.

As described above, the acoustic characteristics processing unit 31 performs the third acoustic characteristics processing, so that it is possible to output in conjunction with climate change in a scene a voice of a conversation partner to which appropriate acoustic characteristics for each weather have been applied.

As described above, by applying to a voice of a conversation partner an acoustic effect matching an environment, a weather, or the like felt as visual information when the user sees a video of a scene similarly to playback of an environment sound, the metaverse virtual space system 11 can maintain user experiences of being present in a virtual space when the users in the same scene are conversing by voice chat. Consequently, the metaverse virtual space system 11 can give the users an experience effect of a high sense of immersiveness, sense of presence, sense of reality, sense of existence, and the like different from those of conventional techniques. Furthermore, the metaverse virtual space system 11 may perform processing of applying acoustic characteristics to the voice of the user that the user itself can hear depending on processing capability of the entire system.

Note that, as described above, the acoustic characteristics application unit 45 adjusts the reverberation amount based on attribute information such as the degree of intimacy or the degree of contribution, and, in addition, may also adjust the reverberation amount according to a destination of speech, for example. That is, while the reverberation amount of the voice of the conversation partner is suppressed for the user itself, and ease of hearing is prioritized, the reverberation amount of a voice may be adjusted to an environment by prioritizing the sense of presence if the voice is not the voice for the user itself.

Furthermore, the acoustic characteristics application unit 45 can detect feelings of the conversation partner, increase the reverberation amount for speech of a partner whose emotion amount such as joy or sadness is great, and make a listener readily notice the voice of the conversation partner. Furthermore, the acoustic characteristics application unit 45 may change the reverberation amount according to a distance to a position of the conversation partner, and can, for example, increase the reverberation amount more for a conversation partner at a more distant place, and make a listener readily notice the voice of the conversation partner. Furthermore, the acoustic characteristics application unit 45 may change the reverberation amount according to the number of conversation partners, and can, for example, increase the reverberation amount more as the number of conversation partners is larger, and make a listener readily notice the voice of the conversation partner. Furthermore, the acoustic characteristics application unit 45 may change the reverberation amount according to a scenario of a direction, and can, for example, increase the reverberation amount of a voice of a conversation partner at a climax scene, and make a listener readily notice the voice of the conversation partner.

Note that the present technology is not limited to application to the metaverse virtual space, and can be applied to exaggerate an acoustic sound as an experience in an Augmented Reality (AR) space, a real space, or the like and apply acoustic characteristics to voice chat. Furthermore, the present technology is applicable to a wide range of business such as entertainment, education, and work assist that require utilization of voice chat.

### Configuration Example of Computer

Next, the above-described series of processing (information processing method) can be also executed by hardware and can be also executed by software. In a case where the series of processing is executed by software, a program that configures the software is installed in a general-purpose computer or the like.

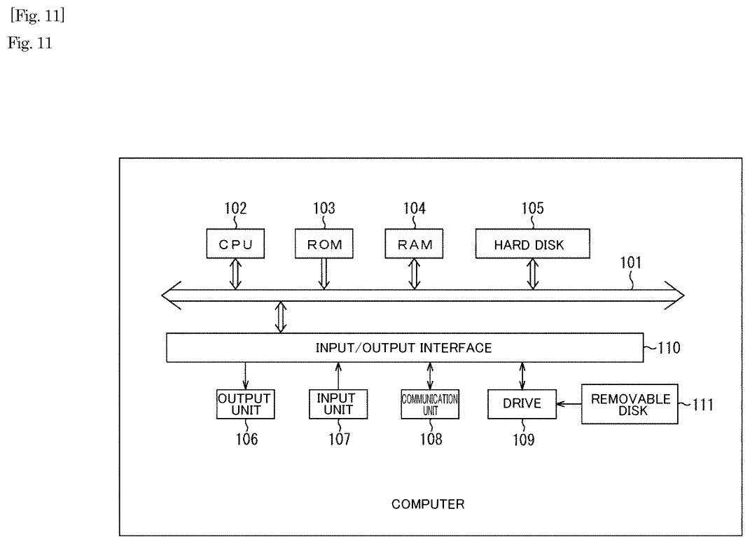

FIG. 11 is a block diagram illustrating a configuration example of an embodiment of a computer in which a program executing the above-described series of processing are installed.

The program can be recorded in advance in a hard disk 105 or a ROM 103 as a recording medium built into the computer.

Alternatively, the program can be stored (recorded) in a removable recording medium 111 driven by a drive 109. The removable recording medium 111 can be provided as so-called package software. Here, examples of the removable recording medium 111 include a flexible disc, a Compact Disc Read Only Memory (CD-ROM), a MagnetoOptical (MO) disc, a Digital Versatile Disc (DVD), a magnetic disk, and a semiconductor memory.

Note that the program can be installed in the computer from the removable recording medium 111 as described above, or can be downloaded to the computer via a communication network or a broadcasting network and installed in the built-in hard disk 105. That is, for example, the program is transferred from the download site to the computer wirelessly via an artificial satellite for digital satellite broadcasting, or transferred to the computer by wire via a network such as a Local Area Network (LAN) or the Internet.

The computer includes a built-in Central Processing Unit (CPU) 102. An input/output interface 110 is connected to the CPU 102 via a bus 101.

When a user inputs an instruction by, for example, operating an input unit 107 through the input/output interface 110, the CPU 102 executes a program stored in the Read Only Memory (ROM) 103 in accordance with the instruction. Alternatively, the CPU 102 loads a program stored in the hard disk 105 into a Random Access Memory (RAM) 104 and executes the program.

As a result, the CPU 102 performs processing according to the above-described flowcharts or processing executed by components of the above-described block diagrams. Then, the CPU 102 causes an output unit 106 to output a processing result, causes a communication unit 108 to transmit the processing result, and causes the hard disk 105 to record the processing result, for example, via the input/output interface 110 as necessary.

The input unit 107 is composed of a keyboard, mouse, microphone, and the like. Furthermore, the output unit 106 is configured by a Liquid Crystal Display (LCD), a speaker, or the like.

The processing executed by the computer in accordance with the program described herein does not necessarily need to be executed chronologically in the order described as the flowcharts. In other words, the processing executed by the computer in accordance with the program also includes processing that is executed in parallel or individually (e.g., parallel processing or processing by objects).

Furthermore, the program may be a program processed by one computer (processor) or may be distributed and processed by a plurality of computers. Furthermore, the program may be a program transmitted to a remote computer to be executed.

Moreover, in this description, a system means a set of a plurality of components (including devices and modules (parts)) regardless of whether or not all the components are contained in the same casing. Accordingly, a plurality of devices accommodated in separate casings and connected via a network and one device in which a plurality of modules are accommodated in one casing are all systems.

For example, a configuration described as one device (or processing unit) may be divided and configured as a plurality of devices (or processing units). On the other hand, the configuration described above as a plurality of devices (or processing units) may be collectively configured as one device (or processing unit). Furthermore, of course, a configuration other than the above may be added to the configuration of each device (or each processing unit). Furthermore, part of the configuration of a device (or processing unit) may be included in the configuration of another device (or another processing unit) as long as the configuration or the operation of the system as a whole is substantially the same.

Furthermore, for example, the present technology may have a cloud computing configuration in which one function is shared with and processed by a plurality of devices via a network.

Furthermore, for example, the above-described program can be executed in any device. In this case, the device only needs to have necessary functions (functional blocks and the like) and to be able to obtain necessary information.

Furthermore, for example, the respective steps described in the above-described flowchart may be executed by one device or in a shared manner by a plurality of devices. Furthermore, in a case where one step includes a plurality of steps of processing, the plurality of steps of processing included in this one step may be executed by one device or by a plurality of devices in a shared manner. In other words, it is also possible to execute the plurality of processing included in the one step as processing of a plurality of steps. On the other hand, it is also possible to execute processing described as a plurality of steps collectively as one step.

Note that, for a program executed by a computer, processing of steps describing the program may be executed chronologically in order described in this description or may be executed in parallel or individually at a necessary timing such as the time of invoking. That is, the processing of the respective steps may be executed in an order different from the above-described order as long as there is no contradiction. Furthermore, the processing of the steps describing this program may be executed in parallel with processing of another program, or may be executed in combination with the processing of the other program.

Note that the present technology described as various modes in the present description may be implemented independently alone as long as no contradiction arises. Of course, any plurality of present technologies may be implemented together. For example, some or all of the present technologies described in several embodiments may be implemented in combination with some or all of the present technologies described in the other embodiments. Furthermore, part or all of any above-described present technology can also be implemented together with another technology which has not been described above.

### Combination Example of Configuration

The present technology can also have the following configuration.
(1)

An information processing device includes:
a voice acquisition unit that, when a second avatar associated with a second user is present in a scene or a plurality of areas associated with a virtual space in which a first avatar associated with a first user is present, acquires a voice of the second user;
an acoustic environment determination processing unit that performs acoustic environment determination processing of determining an acoustic environment of the scene or the areas in which the first avatar is present based on a collider associated with the scene or the areas; and
an acoustic characteristics application unit that applies acoustic characteristics matching a processing result of the acoustic environment determination processing to the voice of the second user.
(2)

The information processing device described in above (1) further includes an output unit that outputs, to a terminal associated with the first user, information indicating the voice of the second user to which the acoustic characteristics have been applied.
(3)

In the information processing device described in above (1),
the acoustic environment determination processing unit acquires an acoustic ID associated with the collider that a determination ray output from a top of a head of the first avatar toward above a sky in the scene or the areas has hit, and
the acoustic characteristics application unit applies acoustic characteristics identified based on the acoustic ID to the voice of the second user.
(4)

In the information processing device described in above (3),
the first user can select a desired scene of a plurality of the scenes, and move the first avatar, and
the acoustic characteristics application unit applies acoustic characteristics to the voice of the second user in conjunction with the movement of the first avatar, the acoustic characteristics being suitable to the acoustic environment in the scene that is a movement destination.
(5)

In the information processing device described in above (3) or (4), the acoustic characteristics application unit adjusts a reverberation amount for the voice of the second user based on predetermined attribute information.
(6)

In the information processing device described in any one of above (3) to (5), when spatial transformation occurs covering the first avatar and the second avatar present in the scene, the acoustic environment determination processing unit performs the acoustic environment determination processing of determining the acoustic environment of a transformed space using a space collider provided covering the transformed space, and thereby acquires the acoustic ID associated with the space collider.
(7)

In the information processing device described in any one of above (3) to (6), when climate change occurs in the scene, the acoustic characteristics application unit acquires acoustic characteristics matching a weather in a current scene by referring to a weather database in which acoustic characteristics matching a weather after the climate change are registered in addition to acoustic characteristics suitable to the acoustic environment matching the processing result of the acoustic environment determination processing, and applies the acoustic characteristics.
(8)

In the information processing device described in above (1), the acoustic characteristics application unit controls the acoustic characteristics to be applied to the voice of the second user based on a distance between the first avatar and the second avatar in the virtual space.
(9)

In the information processing device described in above (8), when the distance exceeds a predetermined value, the acoustic characteristics application unit performs processing of muting the voice of the second user.
(10)

In the information processing device described in above (1), the acoustic characteristics application unit controls the acoustic characteristics to be applied to the voice of the second user based on a number of avatars present in the scene or the areas.
(11)

In the information processing device described in above (10), when the number of avatars exceeds a predetermined value, the acoustic characteristics application unit adjusts a reverberation amount for the voice of the second user based on predetermined attribute information.
(12)

An information processing method including at an information processing device:
when a second avatar associated with a second user is present in a scene or a plurality of areas associated with a virtual space in which a first avatar associated with a first user is present, acquiring a voice of the second user;
performing acoustic environment determination processing of determining an acoustic environment of the scene or the areas in which the first avatar is present based on a collider associated with the scene or the areas; and
applying acoustic characteristics matching a processing result of the acoustic environment determination processing to the voice of the second user.
(13)

A program causing a computer of an information processing device to execute information processing including:
when a second avatar associated with a second user is present in a scene or a plurality of areas associated with a virtual space in which a first avatar associated with a first user is present, acquiring a voice of the second user;
performing acoustic environment determination processing of determining an acoustic environment of the scene or the areas in which the first avatar is present based on a collider associated with the scene or the areas; and
applying acoustic characteristics matching a processing result of the acoustic environment determination processing to the voice of the second user.

Note that the present embodiment is not limited to the embodiment described above, and various changes can be made without departing from the gist of the present disclosure. Moreover, the effects described in this description are merely examples and are not limited, and other effects may also be present.

### REFERENCE SIGNS LIST

11 Metaverse virtual space system
21 Server
22 Client terminal
23 Network
31 Acoustic characteristics processing unit
41 Virtual space management unit
42 Environmental sound acquisition unit
43 Voice acquisition unit
44 Acoustic environment determination processing unit
45 Acoustic characteristics application unit
46 Voice data output unit

1. An information processing device comprising:
a voice acquisition unit that, when a second avatar associated with a second user is present in a scene or a plurality of areas associated with a virtual space in which a first avatar associated with a first user is present, acquires a voice of the second user;
an acoustic environment determination processing unit that performs acoustic environment determination processing of determining an acoustic environment at a position of the virtual space at which the first avatar is present based on a collider associated with the scene or the areas; and
an acoustic characteristics application unit that applies acoustic characteristics matching a processing result of the acoustic environment determination processing to the voice of the second user.

2. The information processing device according to claim 1, further comprising an output unit that outputs, to a terminal associated with the first user, information indicating the voice of the second user to which the acoustic characteristics have been applied.

3. The information processing device according to claim 1,
the acoustic environment determination processing unit acquires an acoustic ID associated with the collider that a determination ray output from a top of a head of the first avatar toward above a sky in the scene or the areas has hit, and
the acoustic characteristics application unit applies acoustic characteristics identified based on the acoustic ID to the voice of the second user.

4. The information processing device according to claim 1, wherein
the first user can select a desired scene of a plurality of the scenes, and move the first avatar, and
the acoustic characteristics application unit applies acoustic characteristics to the voice of the second user in conjunction with the movement of the first avatar, the acoustic characteristics being suitable to the acoustic environment in the scene that is a movement destination.

5. The information processing device according to claim 3, wherein the acoustic characteristics application unit adjusts a reverberation amount for the voice of the second user based on predetermined attribute information.

6. The information processing device according to claim 3, wherein, when spatial transformation occurs covering the first avatar and the second avatar present in the scene, the acoustic environment determination processing unit performs the acoustic environment determination processing of determining the acoustic environment of a transformed space using a space collider provided covering the transformed space, and thereby acquires the acoustic ID associated with the space collider.

7. The information processing device according to claim 2, wherein, when climate change occurs in the scene, the acoustic characteristics application unit acquires acoustic characteristics matching a weather in a current scene by referring to a weather database in which acoustic characteristics matching a weather after the climate change are registered in addition to acoustic characteristics suitable to the acoustic environment matching the processing result of the acoustic environment determination processing, and applies the acoustic characteristics.

8. The information processing device according to claim 1, wherein the acoustic characteristics application unit controls the acoustic characteristics to be applied to the voice of the second user based on a distance between the first avatar and the second avatar in the virtual space.

9. The information processing device according to claim 8, wherein, when the distance exceeds a predetermined value, the acoustic characteristics application unit performs processing of muting the voice of the second user.

10. The information processing device according to claim 1, wherein the acoustic characteristics application unit controls the acoustic characteristics to be applied to the voice of the second user based on a number of avatars present in the scene or the areas.

11. The information processing device according to claim 10, wherein, when the number of avatars exceeds a predetermined value, the acoustic characteristics application unit adjusts a reverberation amount for the voice of the second user based on predetermined attribute information.

12. An information processing method comprising at an information processing device:
when a second avatar associated with a second user is present in a scene or a plurality of areas associated with a virtual space in which a first avatar associated with a first user is present, acquiring a voice of the second user;
performing acoustic environment determination processing of determining an acoustic environment of the scene or the areas in which the first avatar is present based on a collider associated with the scene or the areas; and
applying acoustic characteristics matching a processing result of the acoustic environment determination processing to the voice of the second user.

13. A program causing a computer of an information processing device to execute information processing including:
when a second avatar associated with a second user is present in a scene or a plurality of areas associated with a virtual space in which a first avatar associated with a first user is present, acquiring a voice of the second user;
performing acoustic environment determination processing of determining an acoustic environment of the scene or the areas in which the first avatar is present based on a collider associated with the scene or the areas; and
applying acoustic characteristics matching a processing result of the acoustic environment determination processing to the voice of the second user.
